(19) United States
(12) Patent Application Publication
(10) Pub. No.: US 2024/0408988 A1
(43) Pub. Date: Dec. 12, 2024

(54) DEVICE AND METHOD FOR PROVIDING AND STOWING A CHARGING CABLE AT A CHARGING STATION

(71) Applicant: Siemens Aktiengesellschaft, Munchen (DE)

(72) Inventors: Albert Völkl, München (DE); Stefan Perras, Eichenau (DE)

(21) Appl. No.: 18/738,262

(22) Filed: Jun. 10, 2024

(30) Foreign Application Priority Data
Jun. 8, 2023 (DE) 10 2023 205 350.0

(51) Int. Cl. B60L 53/37; B60L 53/16; H02G 11/00; H02J 7/00

(52) U.S. Cl. CPC B60L 53/37; B60L 53/16; H02J 7/0042; H02J 7/0047; H02G 11/00

(57) ABSTRACT

A device for providing a charging cable for a vehicle. A carrier structure arranged at a charging zone has an attached charging cable between an electricity source and a charging plug for plugging into the vehicle to be charged. A cable control device has a cable control element for moving the charging cable relative to the carrier structure and for positioning the charging plug in the charging zone. A sensor device detects a charging situation in the charging zone. The sensor device is coupled to the cable control device in such a way that the cable control element can be controlled to position the charging plug in the charging zone based on the detected charging situation in the charging zone.

### CROSS-REFERENCE TO RELATED APPLICATION

This application claims the priority, under 35 U.S.C. § 119, of German Patent Application DE 10 2023 205 350.0, filed Jun. 8, 2023; the prior application is herewith incorporated by reference in its entirety.

### FIELD AND BACKGROUND OF THE INVENTION

The present invention relates to a device and a method for providing a charging cable based on an occupancy state of a charging zone with a vehicle.

In addition to the electrification of smaller vehicles, such as automobiles, the electrification of commercial vehicles, such as trucks, is also strived for. The operation of commercial vehicles is highly cost-driven, which is why, when they are electrified, additional downtimes caused by charging breaks for the high voltage battery should be avoided. For this reason, it is advantageous to construct a charging infrastructure, for example at the loading and unloading sites of trucks. Since there is often little space for maneuvering in truck and bus depots, there is a risk of charging columns or charge distributors (dispensers) being damaged by maneuvering operations and thus a risk that the charging points fail.

One possible way of reducing the risk of damage is to fit the dispenser or the charging column at a sufficient distance above the roadway. However, in this case, the cable management of the charging cables represents a particular challenge, since the charging cable must reach into the maneuvering region of the truck and the charging plug or the charging cable should likewise not be exposed to the risk of damage.

It often happens that, after a process of charging a truck, the cable management is not operated correctly and the charging cable is still in the danger region or in the charging zone at the truck. If the charged truck leaves the charging zone or a new truck enters the charging zone, damage to the charging plug, the charging cable or the truck itself can therefore occur.

### SUMMARY OF THE INVENTION

It is accordingly an object of the invention to provide a charge cable management system which overcomes a variety of the disadvantages associated with the heretofore-known devices and methods of this general type and which provides for techniques for improved provision of a charging cable.

With the above and other objects in view there is provided, in accordance with the invention, a device for providing a charging cable for charging a vehicle, the device comprising:
a carrier structure to be arranged at a charging zone for charging the vehicle;
a charging cable fastened to the carrier structure, the charging cable being connected, or connectible, to an electricity source and having a charging plug for plugging into the vehicle to be charged;
a cable control device including a cable control element coupled to the charging cable and enabling the charging cable to be movable relative to the carrier structure for positioning the charging plug in the charging zone; and
a sensor device connected to the cable control device, the sensor device being configured for detecting a charging situation in the charging zone for charging the vehicle to enable the cable control element to be controlled to position the charging plug in the charging zone based on a detected charging situation in the charging zone.

According to a first aspect of the present invention, there is described and specified a device for providing a charging cable for a vehicle. The device has a carrier structure which is designed to be arranged at a charging zone for charging a vehicle. The device also has a charging cable which is connected or can be connected to an electricity source, or power source, and has a charging plug for plugging into a vehicle to be charged. The charging cable is fastened to the carrier structure. The device also has a cable control device having a cable control element which is coupled to the charging cable in such a way that the charging cable is movable relative to the carrier structure in order to position the charging plug in the charging zone.

The device also has a sensor device for detecting a charging situation in the charging zone for charging a vehicle, wherein the sensor device is coupled to the cable control device in such a way that the cable control element can be controlled to position the charging plug in the charging zone based on the detected charging situation in the charging zone.

According to a further aspect, a method for providing a charging cable for a vehicle using a device described above is presented. The method has at least a step of detecting a charging situation in the charging zone for charging a vehicle by means of the sensor device and of positioning the charging plug in the charging zone based on the detected charging situation in the charging zone by means of the cable control element.

The vehicle may be an electrically operated vehicle, for example a purely electrically operated vehicle or a hybrid vehicle, which has a rechargeable battery. The vehicle has in particular a charging socket into which the charging plug of the charging cable is pluggable. The vehicle is, for example, an electrically operated automobile or a commercial vehicle, such as a truck, a bus, a construction machine or an agricultural machine.

The charging zone describes a region of the ground in which the charging cable can be moved in order to be coupled to the vehicle and to charge the vehicle. The charging zone has a predetermined area on the ground, wherein the charging plug is plugged into the vehicle only in the charging zone.

The carrier structure serves for fastening the device components to a building or to the ground. The carrier structure carries the charging cable in particular. Furthermore, the cable control device with the corresponding cable control element can be provided on the carrier structure. Furthermore, sensor elements of the sensor device for detecting the charging situation can be arranged. In another exemplary embodiment, an electricity source and/or a charge distributor (dispenser), to which the charging cable is coupled, is/are arranged on the carrier structure. The carrier structure is designed, for example, as a ground support and/or as a crossbeam.

The cable control device has one or more cable control elements. The cable control element is coupled to the charging cable and can move the charging cable relative to the carrier structure. In this case, the cable control element is designed such that regions of the charging cable, in particular the charging plug, can be transported from outside into the charging zone itself and, in addition, the charging cable and accordingly the charging plug can be transported to a desired position within the charging zone and positioned. As described below, the cable control element can be a control rod which is pivotably fastened to the carrier structure, for example. The length of the control rod may also be adjustable. In another exemplary embodiment described below, the cable control device can be a cable pull device and the cable control element can be a carrier cable, for example.

The sensor device is designed to detect a charging situation in the charging zone for charging a vehicle. The charging situation describes, for example in a first aspect, whether a vehicle is positioned in the charging zone or whether there is no vehicle in the charging zone. In addition, the charging situation defines, according to another aspect, for example, the orientation and position of the vehicle within the charging zone. Furthermore, according to another aspect, the charging situation can describe a charging state in the charging zone, for example whether there is currently a current flow between the charging plug and the vehicle or whether there is generally mechanical coupling between the charging plug and a charging socket of the vehicle. Preferably, the charging situation describes the position and orientation of a vehicle, so that the sensor device is designed to detect this position and orientation of the vehicle.

The sensor device can accordingly detect one, more or all of the charging situations described above. For this purpose, the sensor device has, for example, suitable sensors which are described by way of example below.

In particular, the sensor device is coupled to the cable control device in such a way that the charging cable or the charging plug can be positioned in the charging zone based on the detected charging situation (and accordingly the current actual position of the charging cable).

If, for example, the sensor device determines that a vehicle is positioned in the charging zone and is accordingly ready for charging, the sensor device can pass the corresponding sensor data to the cable control device so that the cable control device accordingly conveys the charging cable or the charging plug from outside into the charging zone. In the example specifically described, it can be ensured that, during the entry and maneuvering of the vehicle within the charging zone, the charging plug and the charging cable can be placed outside the charging zone, so that the risk of damage to the charging cable due to the vehicle maneuvering is reduced. Only when the sensor device detects that the vehicle is positioned at rest in the charging zone does the cable control device move the charging cable or the charging plug into the charging zone.

For this purpose, the cable control device itself can be coupled to the sensor device and process the sensor data. Furthermore, a common control unit can be arranged, to which the cable control device and the sensor device are coupled. The control unit can receive and process corresponding sensor signals from the sensor device. Based on this, the control unit may be coupled to the cable control device in order to transmit control signals to the cable control elements in order to control and adjust them accordingly. The control unit can be centrally arranged, for example, on the carrier structure.

Controlling the cable control device based on the sensor device, which detects a charging situation, makes it possible to significantly reduce the risk of damage to the charging cable during maneuvering or positioning of the vehicle. In dangerous situations, for example in which the vehicle is maneuvering, the cable control device can position the charging cable at a safe location within the charging zone or out of the charging zone. At the same time, availability of the charging plug can be guaranteed if the charging plug is placed in the charging zone by means of the cable control device if a safe charging situation is detected. Human interaction or the risk of user misconduct can be reduced, since the cable control device can be controlled automatically based solely on the sensor data.

According to another exemplary embodiment, the charging situation describes an occupancy state as regards whether there is a vehicle in the charging zone or whether the charging zone is free of a vehicle. The sensor device is configured to determine the occupancy of the charging zone with the vehicle and controls the cable control device based on the occupancy state. If there is therefore no vehicle in the charging zone, the charging cable and the charging plug are removed from the charging zone and accordingly parked in an inactive state. Only when a vehicle is positioned inside the charging zone does the cable control device control the charging cable into the charging zone. This reduces the risk of damage while maneuvering a vehicle in the charging zone, since the charging cable is parked outside the charging zone in an inactive position.

According to another exemplary embodiment, the sensor device is configured to determine the position and orientation of the vehicle, in particular a charging socket of the vehicle, in the charging zone and controls the cable control device based on the position and orientation of the vehicle in such a way that the position of the charging plug can be adjusted relative to the position of the vehicle. For example, based on the determined orientation position of the vehicle in the charging zone, the charging plug can be transported by means of the cable control device already into the vicinity of the charging socket of the vehicle, with the result that the user can quickly and easily grasp the charging plug and plug it into the charging socket.

According to another exemplary embodiment, the sensor device has a weight sensor which can be installed in a ground region of the charging zone. The weight sensor is configured to determine an occupancy state of the charging zone with the vehicle by measuring the weight of the vehicle and/or to determine the position and orientation of the vehicle in the charging zone. For example, the weight sensor may be integrated in the ground in a predetermined position in the charging zone. The driver of a vehicle to be charged can be instructed to move the vehicle into an exact parking position in the charging zone, thus then ensuring that at least one tire of the vehicle rests on the weight sensor, with the result that it can determine an occupancy state.

Furthermore, a multiplicity of weight sensors may be arranged in the ground of the charging zone, with the result that there is a matrix of weight sensors. The sensor device or control unit can determine the exact location of a weight sensor within the matrix. If a vehicle is now positioned in any orientation in the charging zone, at least one tire or a plurality of tires of the vehicle can be assigned to a certain weight sensor which measures a corresponding weight. Accordingly, in addition to the pure occupancy state of the charging zone, the orientation and position of the vehicle within the charging zone can also be determined based on the matrix of weight sensors.

According to another exemplary embodiment, the sensor device has a capacitive sensor which can be installed in a ground region of the charging zone. The capacitive sensor is configured to determine an occupancy state of the charging zone with the vehicle based on the change in an electrical capacitance (or the electric field) and/or to determine the position and orientation of the vehicle in the charging zone. If there is a vehicle in the vicinity of the capacitive sensor, in particular exactly above the capacitive sensor, the electric field changes and the presence of a vehicle, as well as an orientation of the vehicle, within the charging zone can be determined.

According to another exemplary embodiment, the sensor device has a light source and a light sensor for forming a light barrier, wherein the light source and the light sensor are configured to determine an occupancy state of the charging zone with the vehicle and/or to determine the position and orientation of the vehicle in the charging zone. For example, the light barrier may be oriented transversely to a direction in which the vehicle enters the charging zone. If the vehicle passes through the light barrier and stops, in particular, between the light sensor and the light source, an occupancy state of the charging zone can be determined. In addition, a multiplicity of light barriers, in particular a certain pattern of light barriers, can also be arranged in order to thus consider the entire charging zone. In such an embodiment, in addition to the pure occupancy state, the exact position of the vehicle can also be determined based on the severed light barriers within the charging zone.

According to another exemplary embodiment, the sensor device has a radar sensor, wherein the radar sensor is configured to determine an occupancy state of the charging zone with the vehicle and/or to determine the position and orientation of the vehicle in the charging zone. The radar sensor can determine the occupancy state of the charging zone as well as the positioning of the vehicle within the charging zone based on the time-of-flight measurement of radar waves emitted and reflected at the vehicle. For example, a lidar device can also be mounted in order to cover the charging zone as a sensor field.

According to another exemplary embodiment, the sensor device has an optical sensor. The optical sensor is configured to determine an occupancy state of the charging zone with the vehicle and/or to determine the position and orientation of the vehicle in the charging zone. The optical sensor can record, for example, the light contrasts and determine the occupancy of the vehicle in the charging zone based on this. In particular, the optical sensor is a camera that records an image of the charging zone or video sequences of the charging zone. The occupancy state of the charging zone can be determined based on the image data from the camera.

In one exemplary embodiment, the sensor device has an image processing device which is configured to detect a charging socket of the vehicle based on an image analysis and to control the cable control device based on this. The image processing device can detect, for example, contours that are indicative of a vehicle by means of contrast value analysis and can determine an occupancy state of the charging zone based on this. In particular, the image processing device can determine, for example, a charging socket or a closure flap of a charging socket of a vehicle based on the recorded image data, with the result that, based on this, the cable control device can already position the charging plug in the vicinity of the charging socket.

In this case, the image processing device can resort to databases containing vehicle data which specify, for example, optical recognition data or position data relating to such a closure flap or the charging socket of a particular vehicle. Alternatively, the image processing device can recognize the closure flap or the charging socket by means of artificial intelligence methods.

According to another exemplary embodiment, the charging situation describes a charging state between the charging plug and the vehicle, wherein the charging state defines a coupling of the charging plug to the vehicle and/or a charging current flow between the charging plug and the vehicle. The sensor device is configured to determine the charging state and to control the cable control device based on the charging state. For example, the sensor device may be designed to detect a mechanical coupling between the charging plug and the charging socket.

According to another exemplary embodiment, for determining the charging state, the sensor device has a current sensor which determines a current flow between the charging plug and the vehicle. For example, if there is a current flow between the charging plug and the vehicle, it can be assumed that the charging zone is occupied by a vehicle. Furthermore, a safety function can be presented, according to which a movement of the charging cable is prevented by means of the cable control device when charging the vehicle.

According to another exemplary embodiment, the sensor device has a contact sensor for detecting a (mechanical) coupling between the charging plug and the vehicle. Corresponding mechanical contact or mechanical coupling can be detected by means of the contact sensors on the charging plug and/or the charging socket. Furthermore, the mechanical coupling can be detected by means of the optical sensors described above. If, for example, a decoupling between the charging plug and the charging socket is detected, the cable control device can automatically transport the charging cable or the charging plug to a safe position outside the charging zone. This reduces the risk of damage to the charging cable when removing the vehicle from the charging zone.

According to another exemplary embodiment, the cable control element forms a control rod which is designed to be longitudinally adjustable and/or which can be pivoted in such a way that the charging cable can be pivoted into and out of the charging zone. For example, the charging cable can be coupled to the control rod at one or more fastening points. The charging cable may have loops between the individual fastening points. For example, if the length of the control rod is reduced, large loops exist between the fastening points. When the control rod is extended to its maximum length, the charging cable may be stretched between the fastening points. The control rod may be designed, for example, to be foldable or retractable in a telescopic manner.

Furthermore, the control rod can be fastened to the carrier structure, for example, in a pivotable manner by means of a hinge in order to thus pivot the charging cable into or out of the charging zone. The change in length or the pivoting of the control rod can be controlled, for example, by the cable control device by means of an electrical actuator.

According to another exemplary embodiment, the cable control device is fastened to the carrier structure. Further, the cable control device has a cable pull device having a carrier cable as a cable control element. The carrier cable is fastened between a suspension point of the charging cable and the carrier structure, wherein the cable pull device is designed such that the length of the carrier cable can be adjusted in such a way that a distance between the first suspension point and the ground can be adjusted based on the charging situation.

The cable pull device is fastened to the carrier structure, comprising, for example, a crossmember which runs transversely over the charging zone. The first cable pull device has the carrier cable which fastens the charging cable to the suspension point. In other words, the charging cable hangs down from the carrier structure by way of the carrier cable. The carrier cable can be fastened to the charging cable, for example in a detachable or non-detachable manner, at the first suspension point. The suspension points define the section or point at which the carrier cable(s) is/are fastened to the charging cable.

The carrier cables can be produced, for example, from plastic or from natural materials, such as hemp. Further, within the scope of the present invention, a chain, for example made of metal, or a strap or belt may also be a carrier cable.

As a result of the cable lengths of the carrier cables being set, the ground clearance between the suspension points and the ground is individually set. Thus, in an inactive state in which the sensor device determines that no vehicle is positioned in the charging zone, the suspension point can be adjusted in the direction of the carrier structure such that the charging cable is far from the ground in the vicinity of the carrier structure. After the sensor device determines that a vehicle has maneuvered, in particular under the carrier structure, and is positioned at a predetermined position or charging position relative to the carrier structure, the free cable length of the carrier cable can be increased specifically such that a user can grasp the charging plug and can plug it into the charging socket of the vehicle.

According to another exemplary embodiment, the cable control device has a further cable pull device having a further carrier cable as a cable control element, wherein the further cable pull device is fastened to the carrier structure at a distance from the cable pull device. The further carrier cable is fastened between a further suspension point of the charging cable, which is at a distance from the suspension point, and the carrier structure, wherein the cable pull device and the further cable pull device are each designed such that the lengths of the carrier cable and of the further carrier cable can be adjusted independently of one another such that a distance of the suspension point and of the further suspension point to the ground can be adjusted based on the charging situation.

According to the exemplary embodiment, the carrier cables are fastened to the carrier structure at a distance from one another and hold corresponding sections of the charging cable at suspension points that are at a distance from one another. Each of the carrier cables can individually adjust the distance between the corresponding suspension point and the carrier structure. In the case of an arrangement with two cable pull devices, the charging cable first of all extends from a coupling point on the carrier structure to the first cable pull device, or to a coupling at the first suspension point. From there, the charging cable extends to the second cable pull device, or to the second suspension point on the second carrier cable. From the second suspension point, the charging cable extends onward as far as its end, at which the charging plug is arranged. In further exemplary embodiments, yet further cable pull devices with further suspension points can be provided after the second suspension point.

Accordingly, the cable pull device is fastened, in a detachable or non-detachable manner, to the charging cable at the further suspension point by way of the further carrier cable, such that the charging cable is suspended from the carrier structure by way of the further carrier cable. Depending on the position and orientation of the vehicle in the charging zone, the cable control device can adjust the lengths of the carrier cables such that not only a vertical but also a horizontal position of the charging plug can be automatically adjusted.

According to another exemplary embodiment, the charging cable extends from a coupling point with the carrier structure to the suspension point and then to the further suspension point, wherein the charging cable is arranged on the carrier structure, the cable pull device and the further cable pull device in such a way that the coupling point is between the suspension point and the further suspension point along a horizontal direction component.

In other words, the charging cable initially hangs down from the carrier structure from the coupling point. Subsequently, the charging cable extends to the first suspension point, forms a loop and extends in the opposite direction to the second suspension point. The region of the charging cable between the coupling point and the second suspension point thus forms a C-shaped course. The region of the loop at the first suspension point can be adjusted flexibly in the direction of the ground. Accordingly, the region at the charging plug or at the second suspension point can also be adjusted variably relative to the ground. The shape of the cable course of the charging cable can be set depending on how the length ratios between the first carrier cable and the second carrier cable are formed. Since the carrier cables are arranged in an immovable manner, i.e. so as not to be movable along the charging cable, a different setting of the cable lengths of the carrier cables not only changes a vertical position of the suspension points above the ground, but also changes a horizontal position of the suspension points and accordingly of the charging plug. With the described exemplary embodiment, it is thus possible, in addition to a vertical position, for a horizontal position of the charging plug to likewise be set without the user having to use significant muscular strength and without the vehicle needing to be positioned exactly at a predetermined position for charging.

According to another exemplary embodiment, the cable pull device has an electrical controllable cable winch, wherein the cable winch can be controlled based on the detected charging situation. In particular, this adjusts the length of the corresponding carrier cable. The cable winch has for example an electric drive motor, which drives the cable winch as appropriate. Accordingly, the further cable pull device may also have an electrical controllable cable winch which is controlled by the cable control device.

Thus, one or more electrical sides can be combined with automatic occupancy detection or the sensor device. This means that occupancy detection can be used to ensure that a vehicle is in the relevant parking space or the charging zone. It can also be determined that the vehicle has reached its end/parking position. This in turn can be used as a trigger to lower the charging cable using the electric winch(es) so that it can be used by the driver or another person.

In addition, occupancy detection can also be used to determine that there is no vehicle in the charging zone, as a result of which automatic lifting of the charging cable can be initiated by means of the cable control device. In addition to occupancy detection, the (mechanical) withdrawal of the charging cable can also be used as a trigger. This can be achieved by monitoring the charging communication. Incorrect lifting or extraction of the charging cable from the charging zone, although there is still a mechanical coupling between the charging plug and the charging socket of the vehicle, can also be prevented by a torque limitation in the electrical cable winches.

The advantage over a manual display and thus lowering and lifting of the charging plug is the time saving, comfort and especially safety. A human error (“forgetting to lift the cable”) and thus possible damage to the cable and the vehicle by maneuvering in confined spaces can be prevented by the automatic detection using the sensor device.

It should be noted that the embodiments described herein represent only a limited selection of possible embodiment variants of the invention. Thus, it is possible to combine the features of individual embodiments suitably with one another such that a multiplicity of different embodiments should be considered to be disclosed to a person skilled in the art with the embodiment variants that are explicit here.

It should be understood that, irrespective of the grammatical gender of a specific term, persons with male, female, or other gender identity are also included.

Other features which are considered as characteristic for the invention are set forth in the appended claims.

Although the invention is illustrated and described herein as being embodied in a controlled provision and stowage of charging cables, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic representation of a device according to the invention, in which a vehicle is present in the charging zone and is coupled to the charging plug.

FIG. 2 shows a schematic representation of the device from FIG. 1, wherein no vehicle is located in the charging zone.

FIG. 3 shows a schematic representation of the cable control device having two cable pull devices, wherein a vehicle is positioned in the charging zone, according to one exemplary embodiment of the present invention.

FIG. 4 shows a schematic representation of the device according to the invention from FIG. 3, wherein no vehicle is located in the charging zone.

Identical or similar components are provided with the same reference signs in the figures. The illustrations in the figures are schematic and not to scale.

### DETAILED DESCRIPTION OF THE INVENTION

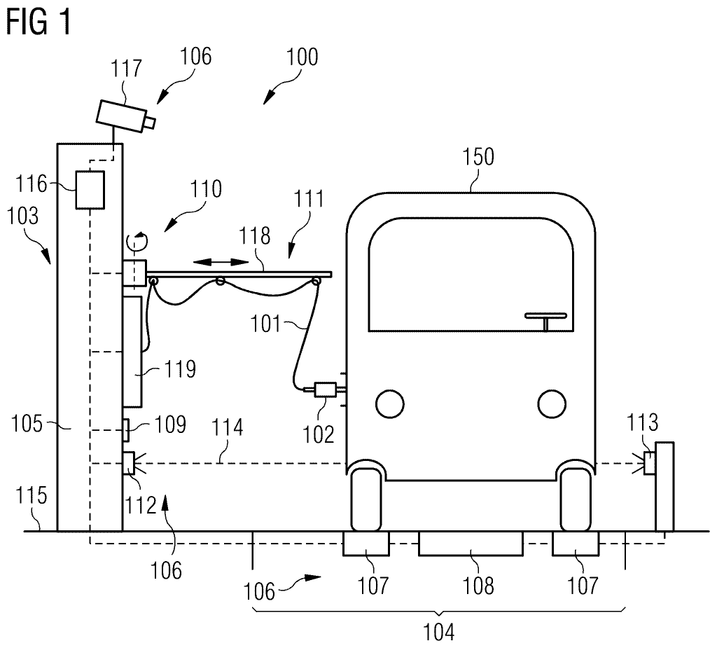

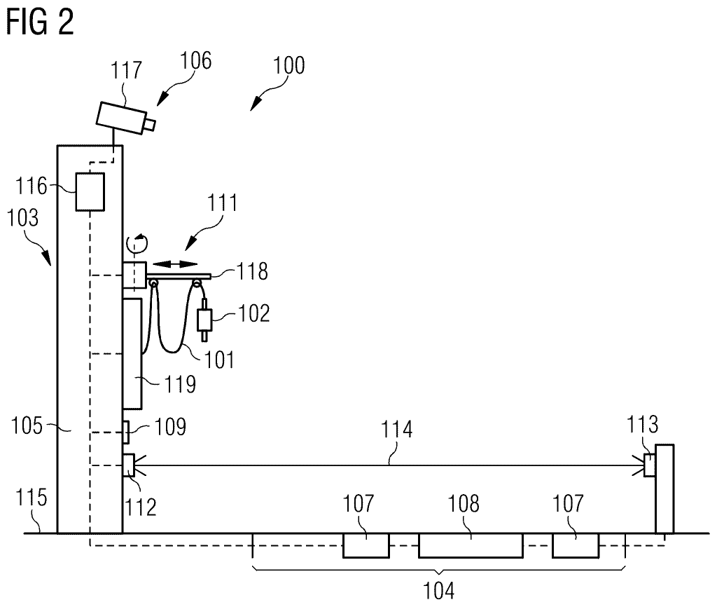

FIG. 1 shows a schematic representation of a device 100 according to the invention, in which a vehicle 150 is present in a charging zone 104 and is coupled to a charging plug 102. FIG. 2 shows a schematic representation of the device 100 from FIG. 1, wherein no vehicle 150 is present in the charging zone 104.

The device has a carrier structure 103 which is arranged at a charging zone 104 for charging a vehicle 150. The device has a charging cable 101, which can be connected to an electricity source, or power source, and a charging plug 102 for plugging into a vehicle 150 to be charged. The charging cable 101 is fastened to the carrier structure 103. The device 100 further has a cable control device 110 having a cable control element 111 which is coupled to the charging cable 101 in such a way that the charging cable 101 is movable relative to the carrier structure 103 in order to position the charging plug 102 in the charging zone 104. Further, the device 100 has a sensor device 106 for detecting a charging situation in the charging zone 104 for charging a vehicle 150, wherein the sensor device 106 is coupled to the cable control device 110 in such a way that the cable control element 111 can be controlled to position the charging plug 102 in the charging zone 104 based on the detected charging situation in the charging zone 104.

The carrier structure 103 is fastened to the ground 115, for example as a support column or ground support 105, and arranged beside the charging zone 104. The carrier structure 103 serves for fastening the device components to a building or to the ground 115. The level determined by the line 115 represents a floor, or floor surface, or support surface on which the vehicle is supported within the charging zone. The carrier structure 103 carries the charging cable 101, in particular. Furthermore, the cable control device 110 with the corresponding cable control element 111 is provided on the carrier structure 103. Further, sensor elements, such as the radar sensor 109 shown or the light source 112, for detecting the charging situation can be arranged on the carrier structure 103. Furthermore, a charge distributor (dispenser) 119, to which the charging cable 101 is coupled, is arranged on the carrier structure 103.

The cable control device 110 has a control rod 118 in the exemplary embodiment shown. The control rod 118 may be designed to be longitudinally adjustable, for example, and/or may be arranged in a pivotable manner on the ground support 105 in such a way that the charging cable 101 can be pivoted into and out of the charging zone 104. For example, the charging cable 101 can be coupled to the control rod 118 at one or more fastening points. The charging cable 101 can have loops between the individual fastening points. For example, if the length of the control rod 118 is reduced (see FIG. 2), large loops exist between the fastening points. When the control rod 118 is extended to its maximum length (for example FIG. 1), the charging cable 101 may be stretched between the fastening points. The control rod 118 may be designed, for example, to be foldable or retractable in a telescopic manner. Furthermore, the control rod 118 can be fastened to the ground support 105, for example, in a pivotable manner by means of a hinge in order to thus pivot the charging cable 101 into or out of the charging zone 104. The change in length or the pivoting of the control rod 118 will be controlled by the cable control device 110 by means of an electrical actuator.

The sensor device 106 is designed to detect a charging situation in the charging zone 104 for charging a vehicle 150. The charging situation describes, for example in a first aspect, whether a vehicle 150 is positioned in the charging zone. In addition, the charging situation defines, according to another aspect, for example, the orientation and position of the vehicle 150 within the charging zone 104.

In FIG. 1, the sensor device 106 detects that a vehicle 150 is positioned in the charging zone 104 and is accordingly ready for charging. Accordingly, the control rod 118 is pivoted out of or into the charging zone 104 such that a charging plug 102 can be coupled to the vehicle 150. In FIG. 2, no vehicle 150 is located in the charging zone 104, with the result that the cable control device 110 has reduced the length of the control rod 118 or has pivoted it out of the charging zone 104. Thus, the charging cable 101 and in particular the charging plug 102 lie outside the charging zone 104, thus avoiding damage due to the positioning of the vehicle 150.

A common control unit 116 is provided, to which the cable control device 110 and the sensor device 106 are coupled. The control unit 116 can receive and process corresponding sensor signals from the sensor device 106. Based on this, the control unit 116 may be coupled to the cable control device 110 in order to transmit control signals to the cable control elements (i.e. the control rod 118) in order to control and adjust them accordingly.

The sensor device 106 has, for example, a weight sensor 107 which is installed in the ground 115 of the charging zone 104. The weight sensor 107 is configured to determine an occupancy state of the charging zone 104 with the vehicle 150 by measuring the weight of the vehicle 150.

Furthermore, a multiplicity of weight sensors 107 may be arranged in the ground 115 of the charging zone 101, with the result that there is a matrix of weight sensors 107. In the example shown, for example, two front tires are located on corresponding weight sensors 107, with the result that, in addition to the presence, an exact position of the vehicle 150 in the charging zone 104 can be determined.

Furthermore, the sensor device 106 may have a capacitive sensor 108 which is installed in the ground 115 of the charging zone. The capacitive sensor 108 is configured to determine an occupancy state of the charging zone with the vehicle based on the change in an electrical capacitance (or the electric field). In the example shown, the electric field above the capacitive sensor 108 changes when a vehicle 150 is positioned above it. Based on this, the occupancy state of the charging zone 104 can be determined.

Further, the sensor device 106 may have a light source 112 and a light sensor 113 for forming a light barrier 114, wherein the light source 112 and the light sensor 113 are configured to determine an occupancy state of the charging zone 104 with the vehicle 150. The light barrier 114 may be oriented, for example, transversely to a direction in which the vehicle 150 enters the charging zone 104. If the vehicle passes through the light barrier 114 and stops, in particular, between the light sensor 113 and the light source 112 (see FIG. 1), an occupancy state of the charging zone 104 can be determined.

Further, the sensor device 106 may have a radar sensor 109, wherein the radar sensor 109 is configured to determine an occupancy state of the charging zone 104 with the vehicle 150. The radar sensor 109 can determine the occupancy state of the charging zone 104 as well as the positioning of the vehicle 150 within the charging zone 104 based on the time-of-flight measurement of radar waves emitted and reflected at the vehicle 150.

Further, the sensor device 106 may have an optical sensor 117 or a camera. The optical sensor 117 is configured to determine an occupancy state of the charging zone 104 with the vehicle 150 by processing and analyzing the recorded images accordingly.

The sensor device 106 further has, for example, a contact sensor in order to detect a mechanical coupling between the charging plug 102 and the charging socket of the vehicle 150. Furthermore, the sensor device 106 may have a current sensor which detects a current flow between the charging plug 102 and the vehicle 150. For example, if there is a current flow between the charging plug 102 and the vehicle 150, it can be assumed that the charging zone 104 is occupied by a vehicle 150.

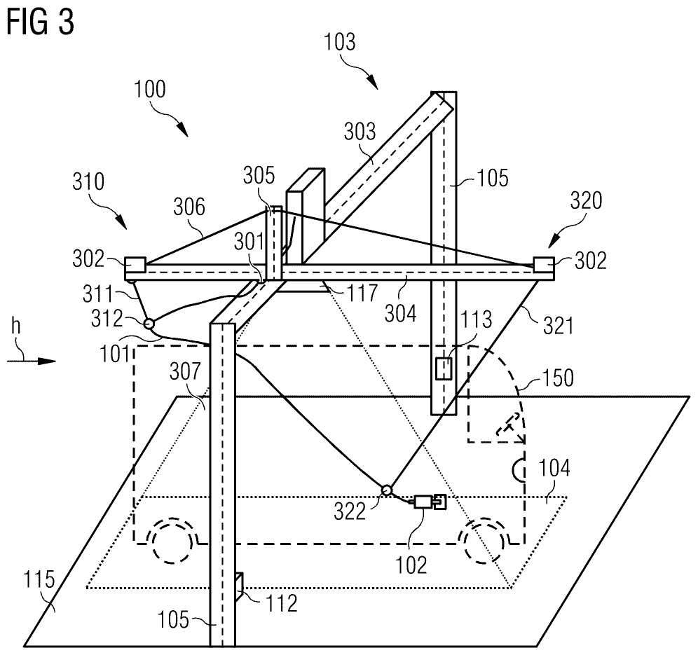

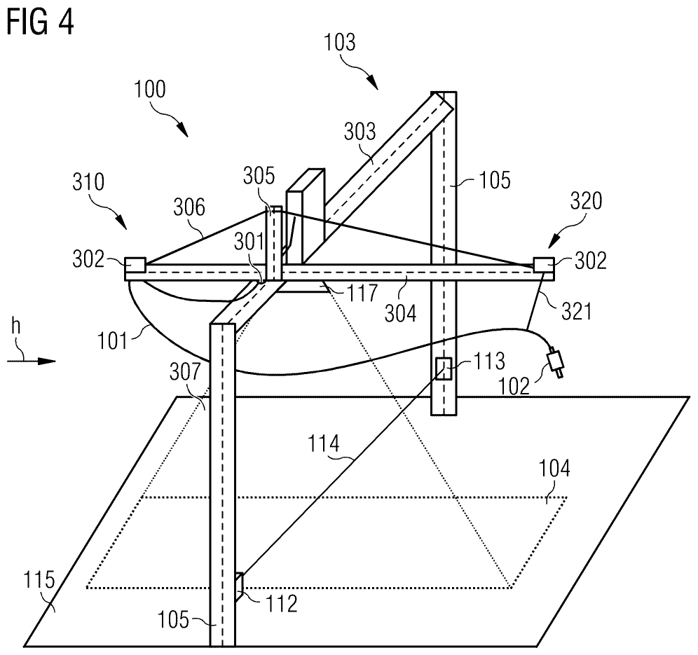

FIG. 3 shows a schematic representation of the cable control device 110 having two cable pull devices 310, 320, wherein a vehicle 150 is positioned in the charging zone 140. FIG. 4 shows a schematic representation of the device 100 according to the invention from FIG. 3, wherein no vehicle 150 is located in the charging zone 104.

The carrier structure 103 has a crossbeam 303 on which a cable pull device 310 and a second cable pull device 320 of the cable control device 110 are arranged. The crossbeam 303 is fastened to the ground 115 by means of two ground supports 105, for example made of a steel structure or concrete, such that a corresponding ground support 105 is provided at both ends of the crossbeam 303.

The carrier structure 103 has a boom 304, on which the cable pull device 310 and the further cable pull device 320 are arranged. The boom 304 is fastened to the crossbeam 303 and projects laterally with respect to the extension direction of the crossbeam 303. For example, charging components, such as a charge distributor (dispenser) 119 for example, may be arranged on the crossbeam 303, wherein the cable pull devices 310, 320 are fastened to the boom 304 at a distance from one another. The boom 106 may consist for example of a solid material or represent a truss.

In particular, the boom 304 is formed at a right angle to the extension direction of the crossbeam 104. The vehicle 150 may enter the device 100 for example in a predetermined entry direction. The crossbeam 303 extends for example transversely to the entry direction, such that the vehicle 150 can be positioned under the crossbeam 303. The boom 304, which extends in particular at a right angle from the crossbeam 303, thus extends parallel to the entry direction and thus along a side face of the positioned vehicle 150. The cable pull devices 310, 320 arranged at a distance from one another on the boom 304 thus extend along the side face of the positioned vehicle 150. The position of the charging plug 102 along the side faces of the vehicle 150 can thus be adjusted by adjusting the lengths of the corresponding carrier cables 311, 312 of the cable pull devices 310, 320.

The first cable pull device 310 has the first carrier cable 311, which fastens the charging cable 101 to the first suspension point 312. In other words, the charging cable 101 hangs down from the boom 304 on the carrier cable 311. The first carrier cable 311 may be fastened, for example in a detachable or non-detachable manner, to the charging cable 101 at the first suspension point 312. Accordingly, the further cable pull device 320 is fastened, in a detachable or non-detachable manner, to the charging cable 101 at the second suspension point 322 by way of the further carrier cable 321, such that the charging cable 101 is suspended from the boom 304 by way of the second carrier cable 321.

Each of the carrier cables 311, 321 can individually adjust the distance between the corresponding suspension point 312, 322 and the carrier structure 103. In the case of an arrangement having two cable pull devices 310, 320, the charging cable 101 first of all extends from a coupling point 301 on the carrier structure 103, always for example on the crossbeam 303 or the boom 304, to the first cable pull device 310, or to a coupling at the first suspension point 312. From there, the charging cable 101 extends to the further cable pull device 320, or to the further suspension point 322 on the further carrier cable 321. From the further suspension point 322, the charging cable 101 extends onward as far as its end, at which the charging plug 102 is arranged.

The ground clearance between the suspension points 312, 322 and the ground 115 is individually adjusted by adjusting the cable lengths of the carrier cables 311, 321. Thus, in an inactive state in which no vehicle 150 is positioned at the device 110 (see FIG. 4), the suspension points 312, 322 can be adjusted in the direction of the carrier structure 103 such that the charging cable 101 is far from the ground in the vicinity of the carrier structure 103. After a vehicle 150 has maneuvered in particular under the crossbeam 303 and is positioned at a predetermined position or charging position relative to the carrier structure 103, the cable lengths of the carrier cables 311, 321 can be increased specifically such that a user can grasp the charging plug 102 and can plug it into the charging socket of the vehicle 115 (FIG. 3).

The charging cable 101 is configured in such a way that the charging cable 101 extends from the coupling point 301 to the first suspension point 312 and then to the second suspension point 322, wherein the charging cable 101 is arranged on the carrier structure 103, the cable pull device 310 and the further cable pull device 320 in such a way that the coupling point 301 is between the first suspension point 311 and the further suspension point 322 along a horizontal direction component h. The charging cable 101 initially hangs down from the crossbeam 303 of the carrier structure 103 from the coupling point 101. The charging cable 101 then extends to the first suspension point 312, forms a loop and extends in the opposite direction to the further suspension point 322. The region of the charging cable 101 between the coupling point 301 and the further suspension point 322 thus forms a C-shaped course. The region of the loop at the suspension point 312 can be flexibly adjusted in the direction of the ground 115 based on the detected sensor data from the sensor device 106. Accordingly, the region at the charging plug 102 or at the further suspension point 322 can be flexibly adjusted in the direction of the ground 115. The shape of the cable course of the charging cable 101 can be set depending on how the length ratios between the carrier cable 311 and the further carrier cable 312 are formed.

The boom 304 has, between two boom ends, a reinforcement beam 305 which protrudes from the boom 304 perpendicularly upward, in the opposite direction to the ground 115. A tensioned reinforcement cable 306 connects the boom ends and the reinforcement beam 305 in order to stabilize the boom 304.

The cable pull device 310 and the second cable pull device 320 each have an electrical cable winch 302. The cable winches 302 can roll up and unwind the carrier cables 311, 321 accordingly. The corresponding cable winches 302 can be controlled by means of the cable control device 110 based on the sensor data from the sensor device 106.

The sensor device 106 may have corresponding sensors as in the exemplary embodiment from FIG. 1. An image region 307 of a camera 117 is shown, in particular, in FIG. 3 and FIG. 4. The image region 307 defines an image of the charging zone 104 or corresponding video sequences of the charging zone 104. The occupancy state of the charging zone 104 can be determined based on the image data or video sequences from the camera 117. The sensor device 106 may further have an image processing device which is configured to detect a charging socket of the vehicle 150 based on an image analysis and to control the cable control device 110 based on this. The image processing device can determine, for example, a charging socket or a closure flap of a charging socket of a vehicle 150 based on the recorded image data, with the result that, based on this, the cable control device 110 can already position the charging plug 102 in the vicinity of the charging socket.

In addition, it should be noted that “comprising” does not exclude any other elements or steps, and “a”, “an” or “one” does not exclude a multiplicity. It should also be noted that features or steps which have been described with reference to one of the above exemplary embodiments can also be used in combination with other features of steps of other above-described exemplary embodiments.

Irrespective of the grammatical gender of a specific term, persons with male, female, or other gender identity are also included.

The following is a summary list of reference numerals and the corresponding structure used in the above description of the invention:
100 Device
101 Charging cable
102 Charging plug
103 Carrier structure
104 Charging zone
105 Ground support
106 Sensor device
107 Weight sensor
108 Capacitive sensor
109 Radar sensor
110 Cable control device
111 Cable control element
112 Light source
113 Light sensor
114 Light barrier
115 Ground, floor
116 Control unit
117 Optical sensor/camera
118 Control rod
119 Charge distributor
150 Vehicle
301 Coupling point
302 Cable winch
303 Crossbeam
304 Boom
305 Reinforcement beam
306 Reinforcement cable
307 Image region
310 Cable pull device
311 Carrier cable
312 Suspension point
320 Further cable pull device
321 Further carrier cable
322 Further suspension point
h Horizontal direction component

1. A device for providing a charging cable for charging a vehicle, the device comprising:
a carrier structure to be arranged at a charging zone for charging the vehicle;
a charging cable fastened to said carrier structure, said charging cable being connected, or connectible, to an electricity source and having a charging plug for plugging into the vehicle to be charged;
a cable control device including a cable control element coupled to said charging cable and enabling said charging cable to be movable relative to said carrier structure for positioning said charging plug in the charging zone; and
a sensor device connected to said cable control device, said sensor device being configured for detecting a charging situation in the charging zone for charging the vehicle to enable said cable control element to be controlled to position the charging plug in the charging zone based on a detected charging situation in the charging zone.

2. The device according to claim 1, wherein:
the charging situation describes an occupancy state of whether or not a vehicle is located in the charging zone; and
said sensor device is configured to determine the occupancy state in the charging zone and to control said cable control device in dependence on the occupancy state.

3. The device according to claim 1, wherein said sensor device is configured to determine a position and an orientation of the vehicle in the charging zone and to control said cable control device based on a determined position and orientation of the vehicle and to enable a position of said charging plug to be adjusted relative to the position of the vehicle.

4. The device according to claim 3, wherein said sensor device is configured to determine a position of a charging socket of the vehicle in the charging zone and to control said cable control device based on a determined position of the charging socket and to enable a position of said charging plug to be adjusted relative to the position of the charging socket.

5. The device according to claim 1, wherein:
said sensor device includes a weight sensor to be installed in a floor region of the charging zone; and
said weight sensor is configured to determine an occupancy state of the charging zone with the vehicle by measuring a weight of the vehicle and/or to determine a position and orientation of the vehicle in the charging zone.

6. The device according to claim 1, wherein:
said sensor device has a capacitive sensor to be installed in a floor region of the charging zone; and
said capacitive sensor is configured to determine at least one of an occupancy state of the charging zone with the vehicle based on a change in an electrical capacitance or to determine a position and orientation of the vehicle in the charging zone.

7. The device according to claim 1, wherein:
said sensor device has a light source and a light sensor disposed to form a light barrier; and
said light source and said light sensor are configured to determine at least one of an occupancy state of the charging zone with the vehicle or position and orientation of the vehicle in the charging zone.

8. The device according to claim 1, wherein:
said sensor device has a radar sensor; and
said radar sensor is configured to determine at least one of an occupancy state of the charging zone with the vehicle or a position and orientation of the vehicle in the charging zone.

9. The device according to claim 1, wherein:
said sensor device has an optical sensor; and
said optical sensor is configured to determine at least one of an occupancy state of the charging zone with the vehicle or a position and orientation of the vehicle in the charging zone.

10. The device according to claim 1, wherein said sensor device comprises an image processing device configured to detect a charging socket of the vehicle based on an image analysis and to control said cable control device accordingly.

11. The device according to claim 1, wherein:
the charging situation describes a charging state between said charging plug and the vehicle;
the charging state describes a coupling of said charging plug to the vehicle and/or a charging current flow between said charging plug and the vehicle; and
said sensor device is configured to determine the charging state and to control said cable control device based on the charging state.

12. The device according to claim 11, wherein, for determining the charging state:
said sensor device has a current sensor configured to determine a current flow between said charging plug and the vehicle; and/or
said sensor device has a contact sensor for detecting a coupling between said charging plug and the vehicle.

13. The device according to claim 1, wherein said cable control element comprises a control rod configured to be longitudinally adjustable and/or to be pivoted for pivoting said charging cable into and out of the charging zone.

14. The device according to claim 1, wherein:
said cable control device is fastened to said carrier structure and includes a cable pull device with a carrier cable forming a cable control element;
said carrier cable is fastened between a suspension point of said charging cable and said carrier structure; and
said cable pull device is configured to adjust a length of said carrier cable such that a distance between said first suspension point and a floor surface can be adjusted based on the charging situation.

15. The device according to claim 14, wherein:
said cable control device has a further cable pull device with a further carrier cable forming a cable control element;
said further cable pull device is fastened to said carrier structure at a distance from said cable pull device;
said further carrier cable is fastened between a further suspension point of said charging cable, which is formed at a distance from said suspension point, and said carrier structure; and
said cable pull device and said further cable pull device are each designed such that a length of said carrier cable and a length of said further carrier cable can be adjusted independently of one another so that a distance of said suspension point and of said further suspension point from the floor surface can be adjusted based on the charging situation.

16. The device according to claim 14, wherein:
said charging cable extends from a coupling point with said carrier structure to said suspension point and then to said further suspension point; and
said charging cable is arranged on said carrier structure, said cable pull device, and said further cable pull device such that said coupling point lies between said suspension point and said further suspension point along a horizontal direction component.

17. The device according to claim 14, wherein said cable pull device comprises an electrically controllable cable winch to be controlled on a basis of the detected charging situation.

18. A method for providing a charging cable for a vehicle, the method comprising:
providing a device according to claim 1;
detecting by the sensor device a charging situation in the charging zone for charging the vehicle; and
positioning the charging plug in the charging zone by the cable control element on a basis of the charging situation in the charging zone.
